(19) United States
(12) Patent Application Publication
(10) Pub. No.: US 2016/0191994 A1
(43) Pub. Date: Jun. 30, 2016

(54) Digital Terrestrial Television On A Mobile Device

(71) Applicant: THOMSON LICENSING, Issy de Moulineaux (FR)

(72) Inventor: Alan J. Stein, Princeton Junction, NJ (US)

(73) Assignee: Thomson Licensing

(21) Appl. No.: 14/962,215

(22) Filed: Dec. 8, 2015

Related U.S. Application Data
(60) Provisional application No. 62/098,375, filed on Dec. 31, 2014.

(51) Int. Cl. H04N 21/4402; H04M 1/02; H04B 1/3805; H04N 21/643; H04N 21/4782; H04N 21/61; H04N 21/443; H04B 1/3888; H04N 5/44

(52) U.S. Cl. CPC H04N 21/440218; H04B 1/3888; H04M 1/0274; H04B 1/3805; H04N 5/4401; H04N 21/4782; H04N 21/6112; H04N 21/6162; H04N 21/6131; H04N 21/4436; H04N 21/64322

(57) ABSTRACT

A digital terrestrial television signal is received by an antenna embedded into a subsequently applied case for a mobile device. The case includes a receiver that receives the signal and processes it into a format that the mobile device can easily implement in applications residing on the mobile device. An optional battery embedded in the case facilitates in providing power to the receiver and/or the mobile device. The receiver can communicate the reformatted signals to the mobile device in a wired and/or wireless manner.

### TECHNICAL FIELD

The present principles relate generally to digital terrestrial television broadcasting, and more particularly, to an apparatus and method for viewing digital terrestrial television broadcasting on a portable or mobile device.

### BACKGROUND

Digital terrestrial television (“DTTV”) systems heretofore transmit video and audio over the airwaves by way of radio signals. DTTV systems can transmit a compressed digital video/audio stream using orthogonal frequency division multiplexing modulation (“OFDM”) or Vestigial Sideband (“VSB”). DTTV is generally regarded as having higher fidelity than regular analog television. DTTV is further recognized for providing quality images at lower operating costs. Analog television transmission can be stationary and can require a user to point an antenna (e.g., roof antenna) towards the nearest transmitter to obtain the reception. Thus, legacy analog transmissions are being replaced with DTTV, due to the inefficient use of the frequency spectrum by typical analog transmission systems. Various DTTV standards are used throughout the world.

### SUMMARY

Methods and apparatus provide means to receive DTTV in a mobile device. In one embodiment, an apparatus can comprise an antenna embedded into the apparatus; a receiver to detect a digital terrestrial television broadcast received by the antenna; and at least one processor to convert the digital terrestrial television broadcast into a digital media stream compatible with at least one application of a mobile device.

In a further embodiment, the at least one processor can be further configured to transmit the digital media stream to the mobile device over a wired or wireless connection.

In another embodiment, the receiver can further comprise a tuner to detect multiple channels in the digital terrestrial television broadcast.

In another example, the digital media stream can be an MPEG-DASH video stream.

In a further embodiment, a method can comprise detecting, using a receiver, a digital terrestrial television broadcast received by an antenna; and converting, using at least one processor, the digital terrestrial television broadcast into a digital media stream compatible with at least one application of a particular mobile device.

In yet a further embodiment, an apparatus can comprise a case to provide a protective enclosure around a mobile device. The case can further comprise a battery. The apparatus can also comprise an interface to electrically couple the battery with the mobile device and a receiver having an antenna. The receiver can be embedded into the case and can be configured to detect a digital terrestrial television broadcast received by the antenna. The battery can be electrically coupled to the receiver so as to enable the battery to also provide power to the receiver. The apparatus can also have at least one processor to convert the digital terrestrial television broadcast into a digital media stream that is compatible with at least one application of a mobile device.

In another example, the at least one processor can be further configured to detect an MPEG-2, an H.264/AVC, or an H.265/HEVC video stream modulated in the digital terrestrial television broadcast. In yet another embodiment, the at least one processor can be configured to demodulate the digital audio/video stream from the digital terrestrial television broadcast.

In a further example, the at least one processor can be configured to alter a packet format of the digital media stream such that the packet format is compatible with the at least one application of the mobile device.

In another example, the at least one application comprises an HTMLS web browser.

In yet another embodiment, a method can include detecting, using an antenna, a digital terrestrial television broadcast; converting, using at least one processor in a receiver, the digital terrestrial television broadcast into a digital media stream that is compatible with at least one application of a mobile device; providing, using the at least one processor, power to the mobile device through an interface between a battery and the mobile device. The interface can be formed in a case providing a protective enclosure around the mobile device. The method can also comprise providing power to the receiver from the battery.

The embodiments, features and advantages of the present principles will be appreciated when considered with reference to the following description of examples and accompanying figures. The following description does not limit the application; rather, the scope of the disclosure is defined by the appended claims and equivalents.

### BRIEF DESCRIPTION OF THE DRAWINGS

FIG. 1 depicts a block diagram of an exemplary apparatus in accordance with an embodiment of the present principles.

FIG. 2 depicts a close up illustration of an exemplary apparatus in accordance with an embodiment of the present principles.

FIG. 3 depicts a block diagram of an exemplary e broadcasting system in accordance with an embodiment of the present principles.

FIG. 4 depicts an exemplary receiver in accordance with an embodiment of the present principles.

FIG. 5 depicts a flow diagram of an exemplary method in accordance with an embodiment of the present principles.

FIG. 6 depicts a further flow diagram of an exemplary method in accordance with an embodiment of the present principles.

FIG. 7 depicts a working example in accordance with an embodiment of the present principles.

FIG. 8 depicts a further working example in accordance with an embodiment of the present principles.

### DETAILED DESCRIPTION

In a typical setting, DTTV signals can be detected by a digital set-top box or tuner in a television set. However, the advent of mobile devices has led to an increased demand for viewing DTTV broadcasts while in transit. In particular, there is an increased demand for viewing DTTV broadcasts in public places away from the home network. Unfortunately, some solutions for viewing DTTV broadcasts in public places can require special software to be installed and/or an antenna to be attached the device. The installation of additional software can be cumbersome for a user in some instances. The attachment of an antenna can be unwieldy and not aesthetically pleasing.

The apparatus and methods disclosed herein can allow a user to receive DTTV broadcasts seamlessly while away from home, without needing to download special media playback software and without having to attach an awkward antenna to the device. Broadcast transmission is a one way transmission (i.e., a transmitter sends a signal but the receiver does not reply to the transmitter) and the techniques herein can convert the broadcast transmission to an IP based two-way network media stream (i.e., replies or acknowledgements can be sent by the receiver in accordance with a protocol). Furthermore, the apparatus and method can prolong the battery life of the mobile device while viewing the DTTV broadcast.

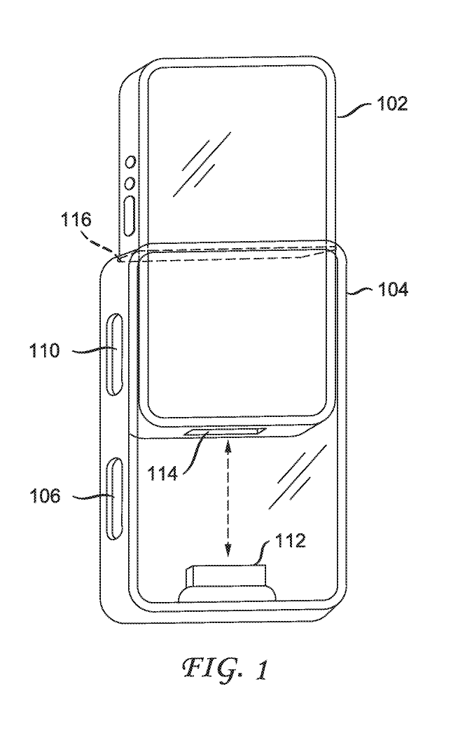

FIG. 1 presents one example of an apparatus in accordance with embodiments of the present principles. In the example of FIG. 1, the apparatus comprises a case 104 to provide a protective enclosure around a mobile device 102. Mobile device 102 can include all the components normally used in connection with a mobile device and can be, for example, a tablet PC, a personal media device (e.g., music player/video viewer and the like) and/or a smartphone, etc. Mobile device 102 can, optionally, be enabled to process wireless communication technology that includes, but is not limited to, GSM, GPRS, EDGE, CDMA, WCDMA, and/or Wi-Fi 802.11. Mobile device 102 can be, for example, further configured to request information from a service provider via a cellular service and to request information from an Internet service provider over the cellular service and/or over a Wi-Fi connection and the like.

Case 104 can further comprise an interface 112 to electrically couple an optional battery pack 106 with mobile device 102. Battery pack 106 can be a battery pack that includes a rechargeable battery (e.g., lithium-polymer, lithium ion etc.) that can be separately charged. In the example of FIG. 1, interface 112 can be electrically coupled to the mobile device through a port 114. This allows optional battery pack 106 to provide additional power to mobile device 102. That is, battery pack 102 can provide power that supplements the power provided by a battery already installed in mobile device 102. Mobile device 102 can already be equipped with its own rechargeable battery. Interface 112 can be compliant with a standard suitable for charging a battery of mobile device 102. For example, mobile device 102 can have an interface 112 with a micro-USB and/or a lightning connector and/or 30-pin connector and the like.

In the example of FIG. 1, mobile device 102 can slide into case 104 through opening 116. However, it is understood that case 104 is merely illustrative and that mobile device 102 can be inserted into case 104 in a variety of ways, including from the front, side and/or bottom and the like. The case itself can also clamp to the phone and/or include multiple pieces that snap and/or slide together to hold the phone in proximity of the case, etc.

Case 104 can also include a receiver 110. As will be discussed in more detail below, receiver 110 can include at least one processor to convert a DTTV broadcast into a digital media stream. Such converted digital media stream can be compatible with at least one application of mobile device 102. The battery pack 106 can also be electrically coupled to receiver 110 to provide power to receiver 110 as it detects and converts the DTTV broadcast. While receiver 110 is shown embedded into case 104, it is understood that receiver 110 can also be embedded into mobile device 102. The receiver 110 can also be electrically coupled to the mobile device 102 such that the receiver is powered by the mobile device 102 instead of the optional battery back 106.

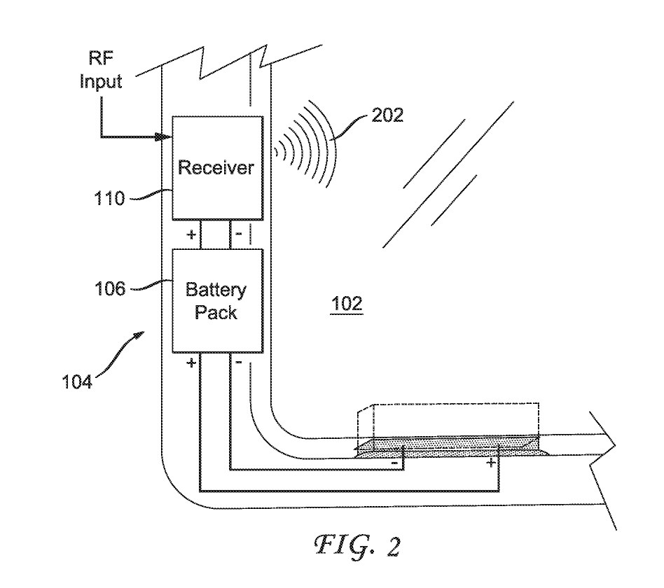

Referring now to FIG. 2, a close up illustration of case 104 is shown. In this example, receiver 110 can detect a radio frequency (“RF”) signal, such as an ultra-high frequency (“UHF”) or very-high frequency (“VHF”) signal. In turn, receiver 110 can transmit a digital stream 202 to mobile device 102 based on the received RF signal. UHF is a frequency band used primarily for television broadcasts. UHF can be between approximately 474 Megahertz (“MHz”) and 862 MHz. VHF is a lower band between approximately 200 MHz and 300 MHz. In the example of FIG. 2, receiver 110 can transmit the digital media stream to mobile device 102 over a wireless connection. Such wireless connection can employ a personal area network protocol that can include, but is not limited to, Bluetooth®, wireless USB, and/or ZigBee® and the like. While the example of FIG. 2 shows the digital stream transmitted over a wireless connection, it is understood that the digital stream can also be transmitted over a wired connection. The wired connection can be through interface 112 and/or port 114 and/or through an additional electrical connection between the receiver 110 and the mobile device 102. Also, it is understood that optional battery pack 106 and receiver 110 can be arranged anywhere within case 104. That is, the placement of the optional battery pack 106 and receiver 110 shown in FIG. 2 is illustrative and is not meant to limit this example.

The example in FIG. 2 also illustrates how optional battery pack 106 can be electrically coupled to both receiver 110 and mobile device 102. In this example, the optional battery pack 106 can extend the battery life of mobile device 102 while simultaneously supplying power to receiver 110. The inclusion of the optional battery pack 106 is advantageous, since the receipt, conversion, and viewing of the DTTV broadcast can require a considerable amount of power. However, in other embodiments the receiver 110 can use power supplied by the mobile device 102.

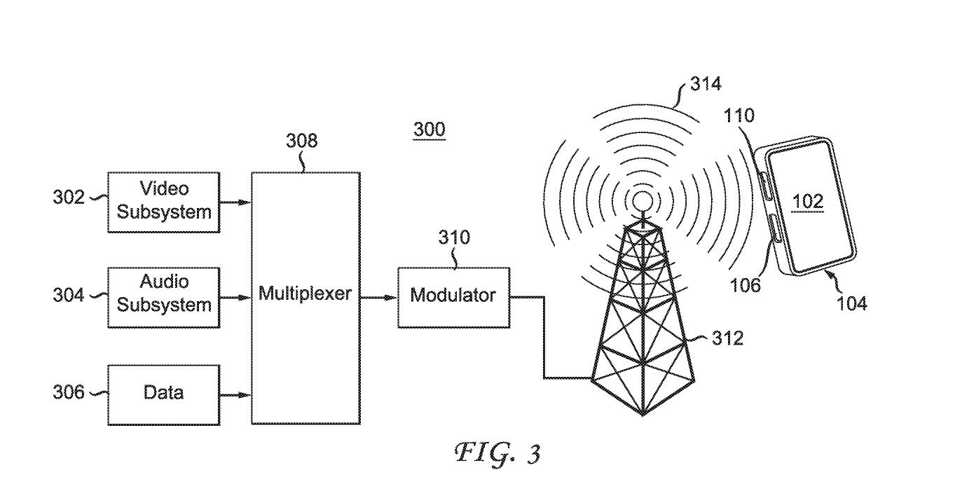

Referring now to FIG. 3, a high level depiction of a DTTV broadcast system 300 is shown. Video subsystem 302 and audio subsystem 304 can be a source of video and audio. Such video and audio can be transmitted over the airwaves. In one example, these systems can be part of any entity that offers video content, such as an over-the-top (“OTT”) content video stream. In one example, the video and audio can be compressed and can be in accordance with a media streaming and compression format that can include, but is not limited to, MPEG-1, MPEG-2, H.264 Advanced Video Coding (“AVC”), or H.265 High Efficiency Video Coding (“HEVC”) and the like. It is understood that the foregoing is a non-exhaustive list and that other media streaming and compression formats can be employed. A data sub system 306 can include any metadata associated with the video and audio supplied by video subsystem 302 and audio subsystem 304. This data can also be transmitted along with the video and audio. The video subsystem 302, the audio subsystem 304, and the data subsystem 306 can be provided as input to multiplexer 308.

Multiplexer 308 can transmit the video subsystem 302, audio subsystem 304, and data subsystem 306 over a single channel to modulator 310. Modulator 310 can modulate the video, audio, and associated data onto a carrier signal using, for example, OFDM or COFDM. FIG. 3 further illustrates a broadcast antenna 312 aerially transmitting a broadcast 314 that carries the video, audio, and associated data. As noted above, the broadcast 314 can be a VHF/UHF broadcast. Broadcast 314 can be detected by receiver 110 embedded in the case 104. As will be discussed in more detail below, receiver 110 can include circuitry for receiving and processing the broadcast 314.

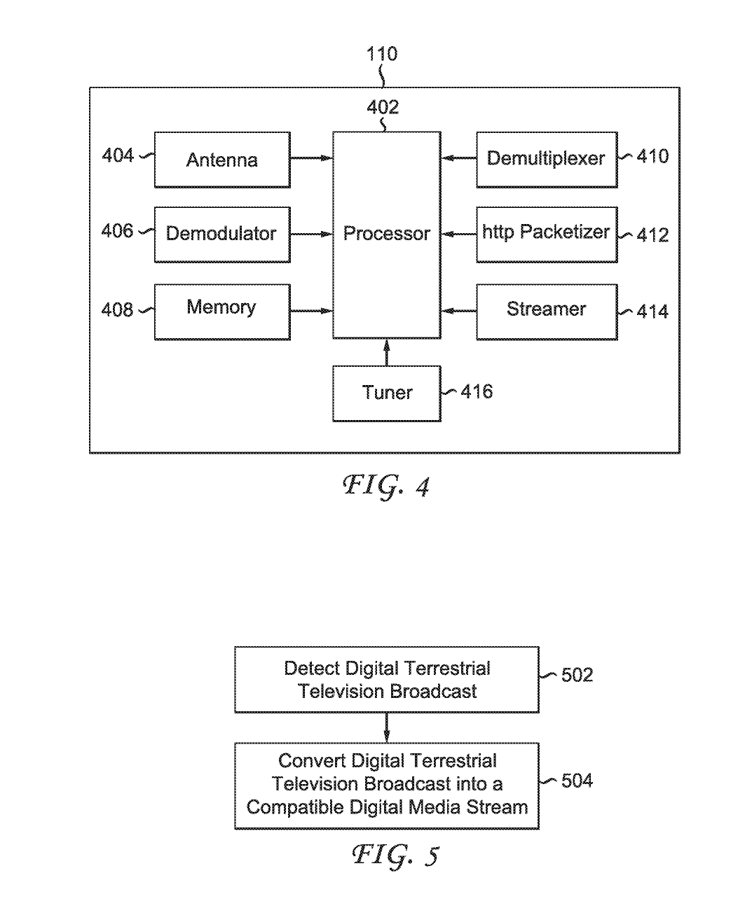

Referring now to FIG. 4, a high level diagram of an example receiver 110 is shown. Receiver 110 can have a processor 402 to manage the components within receiver 110. Processor 402 can be any number of processors that can include, but are not limited to, processors from Intel ® Corporation, STMicroelectronics 551x family, NEC EMMA2, ATI Xilleon, or Broadcom BCM3560 and the like. In another example, processor 402 can be an application specific integrated circuit (“ASIC”). Memory 408 can store instructions and data that can be retrieved and executed by processor 402. Memory 408 can comprise any one of many physical media including, but not limited to, a read-only memory (“ROM”), an erasable programmable read-only memory, a random access memory (“RAM”) device or multiple memory segments organized as dual in-line memory modules (“DIMMs”). Memory 408 can also include any combination of one or more of the foregoing and/or other devices as well. While only one processor and one memory block are shown in FIG. 4, it is understood that receiver 110 can actually comprise additional processors and memories. Furthermore, it is understood that the techniques executed in receiver 110 can be implemented in the form of hardware, software, or a combination of hardware and software.

Receiver 110 can also include an antenna 404 for receiving or absorbing an RF signal, such as a signal in the VHF/UHF frequency band. Since there is a correlation between the physical dimensions of an antenna and its performance, antenna 404 can be designed to allow the receiver 110 to receive signals while maintaining a neat and aesthetically pleasing look for the case 104. Thus, antenna 404 can be, in one embodiment, incorporated inside the case 104 without diminishing the range of frequencies detectable by the antenna 404. In other embodiments, antenna 404 can be an external antenna mounted on and/or in the case 404 or external to the case and electrically coupled to the receiver 404. Tuner 416 can include circuitry to tune antenna 404 and, in one embodiment, allow the antenna to detect an entire VHF/UHF frequency band. Therefore, tuner 416 can enable antenna 404 to detect multiple channels in the broadcast.

Demodulator 406 can be used to extract the video, audio, and other data embedded in the carrier RF signal. Demodulator 406 can also apply error correction to produce the original stream. De-multiplexer 410 can separate the video, audio, and associated data streams to reproduce the original channels that were input into multiplexer 308 in the DTTV broadcast system 300. The bit stream encoded in the VHF/UHF signal of broadcast 208 can be rearranged in time with forward error correction protection. Thus, the original transport stream can be recovered from the signal. The original media stream can include various ultra-high definition (“UHD”), high definition (“HD”) and/or standard definition (“SD”) channels and the like that can be detected by tuner 416. The stream modulated in the carrier signal can also be IP multicast packets using a multicast IPv4 address space and/or a multicast IPv6 address space and the like.

The example of FIG. 4 also shows a hypertext transfer protocol (“HTTP”) packetizer that can obtain the video, audio, and associated data from the carrier and bundle that information into packets that are in accordance with HTTP. HTTP is an application layer protocol designed within the framework of the Internet Protocol Suite. While the examples herein refer to the conversion of the incoming RF signal to a stream of packets compliant with HTTP, it is understood that the incoming signal can be converted into a stream compatible with other protocols.

Streamer 414 can stream the HTTP directly to, for example, a web browser application in mobile device 102. Thus, HTTP packetizer can alter the packet format of the video, audio, and associated data so that it is compatible with a browser application of mobile device 102. As noted above, it is understood that another component can replace the HTTP packetizer so as to rearrange the data into another format compatible with a different type of application. HTTP is used herein for convenience and for illustrative purposes. It is further understood that multiple components can be utilized to convert the digital stream into a stream compatible with more than one application that is installed and/or can be installed in the mobile device 102. Streamer 414 can forward the digital media stream directly to at least one application of the mobile device (e.g., an HTMLS web browser). Streamer 414 can employ adaptive streaming that can adjust the bit rate of the packets in accordance with the bandwidth and CPU processing power of mobile device 102. By way of example, the broadcast transmission can comprise a two layered transmission that allows streamer 414 to receive both layers or ignore one of the layers in accordance with the screen size or processing power of the mobile device 102. One example of a two layered transmission is signal to noise ratio (SNR) scalable video, in which video is coded in the broadcast at different qualities of resolution. Streamer 414 can monitor the status of mobile device 102 to ensure the stream is played back continually.

Both the DTTV broadcasting system 300 and receiver 110 can comply with a DTTV standard. In one example, some embodiments of receiver 110 and DTTV broadcasting system 300 can be in compliance with the Advanced Television Systems Committee (“ATSC”) standards. However, it is understood that some embodiments of DTTV broadcasting system 300 and receiver 110 can comply with other standards that include, but are not limited to, terrestrial integrated services digital broadcasting (“ISDB-T”), terrestrial integrated services digital broadcasting (“DVB-T”) and digital terrestrial multimedia broadcasting (“DTMB”) and the like.

Referring now to FIG. 5, a flow diagram of an example method 500 for displaying DTTV on a mobile device is shown. At block 502, a DTTV broadcast can be detected. As noted above, processor 402 can detect a broadcast using an antenna of a receiver, such as antenna 404 shown in FIG. 4. The original data stream can be extracted using a demodulator, such as demodulator 406. At block 504, the broadcast can be converted into a digital media stream that is compatible with at least one application of a mobile device. As shown in the example receiver of FIG. 4, the extracted media stream can be converted into an HTTP stream that is compatible with, for example, an HTMLS web browser installed in a mobile device. As noted above, the extracted media stream can be converted into a stream compatible with any other type of application that is installed and/or can be installed in the device.

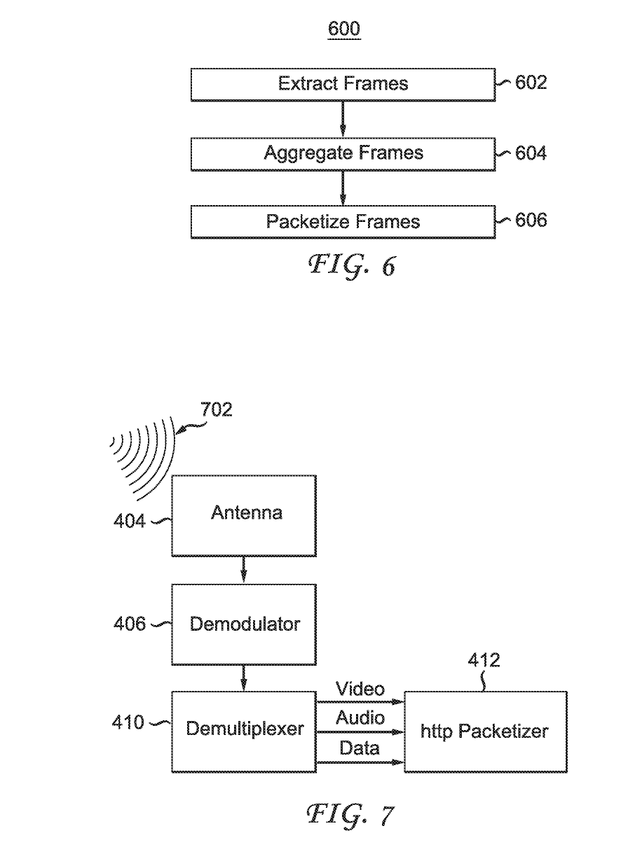

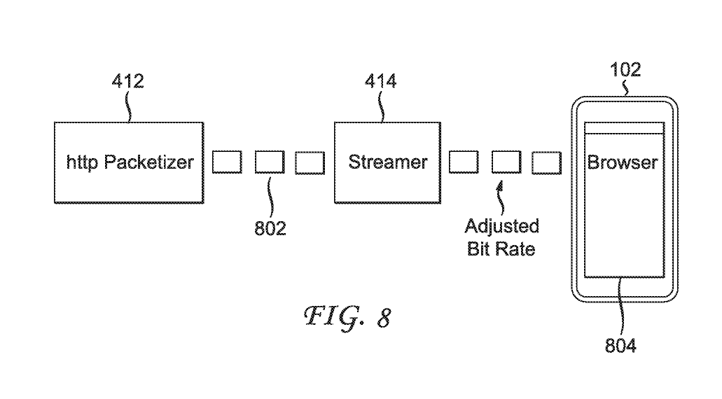

Working examples of the apparatus and method are shown in FIGS. 6-8. In particular, FIG. 6 illustrates a further flow diagram of an example method 600 for displaying DTTV on a mobile device. FIGS. 7-8 are working examples corresponding to the flow diagram of FIG. 6. The actions shown in FIGS. 7-8 will be discussed below with regard to the flow diagram of FIG. 6.

Referring now to FIG. 6, in block 602, video and audio frames can be extracted from a received carrier signal. This can also include decompression and reassembly of the original video, audio, and associated data. Referring now to FIG. 7, antenna 404 is shown detecting a signal 702, which can be UHF or VHF signal carrying the video, audio and/or associated data. The demodulator 406 can extract the data in the carrier and de-multiplexer 410 can separate the signal into a video, audio and/or data stream in accordance with its original format.

Referring back to FIG. 6, the frames can be aggregated, as shown in block 604 and the frames can be packetized, as shown in block 606, so that the digital media stream can be compatible with at least one application of a mobile device. Referring now to FIG. 8, HTTP packetizer 412 can receive the video, audio, and associated data from de-multiplexer 410. In turn, the HTTP packetizer 412 can alter the packet format of the stream to comply with HTTP and forward these packets to streamer 414. FIG. 8 demonstrates how the HTTP packetizer 412 can generate a stream of packets 802 compliant with HTTP and forward them to streamer 414. As noted above, streamer 414 can monitor the bandwidth and CPU processing power of mobile device 102 and adjust the bit rate accordingly. In one example, the streaming protocol can be in accordance with an adaptive streaming protocol, such as MPEG-DASH.

Advantageously, the foregoing apparatus and method allow a user to watch a DTTV broadcast on a mobile device while in and/or away from home. In this regard, the receiver can detect a VHF/UHF signal and convert the signal into a digital stream compatible with at least one application that can run on the device. Furthermore, the receiver can be incorporated into a protective case equipped with an optional battery pack to provide extra power to the receiver and the device. This extra power can prolong the user's DTTV viewing experience, since the conversion of the RF signal to a digital media stream can require a significant amount of energy to maintain.

Although the disclosure herein has been described with reference to particular examples, it is to be understood that these examples are merely illustrative of the principles of the disclosure. It is therefore to be understood that numerous modifications can be made to the examples and that other arrangements can be devised without departing from the scope of the disclosure as defined by the appended claims. Furthermore, while particular processes are shown in a specific order in the appended drawings, such processes are not limited to any particular order unless such order is expressly set forth herein; rather, processes can be performed in a different order or concurrently and steps can be added or omitted.

1. An apparatus comprising:
an antenna embedded into the apparatus;
a receiver to detect a digital terrestrial television broadcast received by the antenna; and
at least one processor configured to convert the digital terrestrial television broadcast into a digital media stream compatible with at least one application of a mobile device.

2. The apparatus of claim 1, wherein the at least one processor is further configured to transmit the digital media stream to the mobile device over a wireless connection.

3. The apparatus of claim 1, wherein the receiver further comprises a tuner to detect multiple channels in the digital terrestrial television broadcast.

4. The apparatus of claim 1, wherein the receiver is compatible with Advanced Television Systems Committee standards.

5. The apparatus of claim 1, wherein the digital media stream is an MPEG-DASH video stream.

6. The apparatus of claim 1, wherein the at least one application comprises an HTMLS web browser.

7. The apparatus of claim 1, further comprising:
a case to provide an enclosure around the mobile device; and
an interface to electrically couple a battery with the mobile device, the battery being further coupled to the receiver so as to enable the battery to provide power to the mobile device and the receiver.

8. A method comprising:
detecting, using a receiver, a digital terrestrial television broadcast received by an antenna; and
converting, using at least one processor, the digital terrestrial television broadcast into a digital media stream compatible with at least one application of a particular mobile device.

9. The method of claim 8, further comprising transmitting, using the at least one processor, the digital media stream to the mobile device over a wired or wireless connection.

10. The method of claim 8, wherein the receiver further comprises a tuner to detect multiple channels in the digital terrestrial television broadcasts.

11. The method of claim 8, wherein the receiver is compatible with Advanced Television Systems Committee standards.

12. The method of claim 8, wherein the application is an HTMLS web browser.

13. The method of claim 8, further comprising:
providing, using the at least one processor, power to the mobile device through an interface between a battery and the mobile device, the interface being formed in a case providing an enclosure around the mobile device;
providing, using the at least one processor, power to the mobile device from the battery through the interface; and
providing, using the at least one processor, power to the receiver from the battery.

14. An apparatus comprising:
a case to provide an enclosure around a mobile device, the case further comprising:
a battery;
an interface to electrically couple the battery with the mobile device;
a receiver having an antenna, the receiver being embedded into the case, the receiver being configured to detect a digital terrestrial television broadcast received by the antenna, the battery being electrically coupled to the receiver so as to enable the battery to provide power to the receiver; and
at least one processor to convert the digital terrestrial television broadcast into a digital media stream that is compatible with at least one application of a mobile device.

15. The apparatus of claim 14, wherein the digital media stream is an MPEG-DASH video stream.

16. The apparatus of claim 15, wherein the at least one processor is further configured to detect an MPEG-2, an H.264/AVC, or an H.265/HEVC video stream modulated in the digital terrestrial television broadcast.

17. The apparatus of claim 14, wherein to convert the digital terrestrial television broadcast into the digital media stream the at least one processor is configured to demodulate the digital stream from the digital terrestrial television broadcast.

18. The apparatus of claim 14, wherein to convert the digital terrestrial television broadcast into the digital media stream the at least one processor is configured to alter a packet format of the digital media stream such that the packet format is compatible with the at least one application of the mobile device.

19. The apparatus of claim 14, wherein the at least one application is an HTMLS web browser.

20. A method comprising:
detecting, using an antenna, a digital terrestrial television broadcast;
converting, using at least one processor in a receiver, the digital terrestrial television broadcast into a digital media stream that is compatible with at least one application of a mobile device;
providing, using the at least one processor, power to the mobile device through an interface between a battery and the mobile device, the interface being formed in a case providing an enclosure around the mobile device; and
providing, using the at least one processor, power to the receiver from the battery.

21. The method of claim 20, wherein the digital media stream is an MPEG-DASH video stream.

22. The method of claim 21, wherein further comprising detecting, using the at least one processor, an MPEG-2, an H.264/AVC, or an H.265/HEVC video stream modulated in the digital terrestrial television broadcast.

23. The method of claim 20, wherein the converting of the digital terrestrial television broadcast comprises demodulating, using the at least one processor, the digital terrestrial television broadcast.

24. The method of claim 20, wherein the converting of the digital terrestrial television broadcast comprises altering, using the at least one processor, a packet format of the digital media stream such that the packet format is compatible with the at least one application of the mobile device.
